(19) United States
(12) Patent Application Publication
(10) Pub. No.: US 2022/0390295 A1
(43) Pub. Date: Dec. 8, 2022

(54) METHOD AND MATERIAL THAT COMPRISES A COMBINATION OF A RUBBER MATRIX AND A PLURALITY OF MICROWIRES MADE OF FERROMAGNETIC MATERIAL, FOR MEASURING INTERNAL STRESS IN A TIRE

(71) Applicant: UNIVERSIDAD TÉCNICA FEDERICO SANTA MARÍA, Valparaíso (CL)

(72) Inventors: Carlos GARCÍA GARCÍA, Valparaíso (CL); Christopher David COOPER VILLAGRÁN, Valparaíso (CL); Claudio Alejandro GONZÁLEZ FUENTES, Valparaíso (CL); Cristian Alberto ROMANQUE ALBORNOZ, Viña del Mar (CL)

(73) Assignee: UNIVERSIDAD TÉCNICA FEDERICO SANTA MARÍA, Valparaíso (CL)

(21) Appl. No.: 17/766,524

(22) PCT Filed: Oct. 1, 2020
(86) PCT No.: PCT/CL2020/050111

§ 371 Date: Apr. 4, 2022

(30) Foreign Application Priority Data
Oct. 4, 2019 (CL) 2836-2019

(51) Int. Cl. G01L 1/12; G01M 17/02; G01B 7/24; B60C 23/06

(52) U.S. Cl. CPC G01L 1/12; G01M 17/02; G01B 7/24; B60C 23/06

(57) ABSTRACT

The present invention is related, but is not restricted, to the field of the study or analysis of materials by determining the chemical or physical properties thereof, in particular the field of the investigation or analysis of materials by using electromagnetic waves, specifically providing a method from measuring internal stress in tires, using a ferromagnetic material.

The invention provides a method for measuring internal stress in a tire, characterized in that it comprises: incorporating into the tire a material that is a combination of a rubber matrix and a plurality of microwires made of a ferromagnetic material; irradiating said tire with electromagnetic waves by means of a transmitting antenna; receiving an electromagnetic wave absorption response from said tire by means of a receiving antenna; and determining the internal stress of the tire by means of a processor operatively connected to said receiving antenna, on the basis of the electromagnetic wave absorption response. The invention further provides a material for measuring the internal stress in a tire, characterized in that it is a combination of a rubber matrix and a plurality of microwires made of a ferromagnetic material.

### TECHNICAL FIELD OF THE INVENTION

The present invention relates, but is not limited, to the field of the investigation or analysis of materials by determination of their chemical or physical properties, particularly to the field of the investigation or analysis of materials by using electromagnetic waves, specifically it provides a method for measuring the internal stress in tires using a ferromagnetic material.

### BACKGROUND OF THE INVENTION

Tires are high-cost supplies in many industries. For example, in the mining industry they are the third most expensive supply. In general, there are methods in the state of the art that base their control on visual inspections and pressure and temperature sensors inside the tire. However, there is a limited capacity to detect anomalies early on, and it is very difficult to predict the behavior of said tire, which could lead to catastrophic failures that could endanger the physical integrity of the vehicle operator and people in the area surrounding the tire.

Among the existing solutions in the state of the art, for example, there is the one proposed in document JP2007003242, which provides a method and apparatus for estimating the amount of deformation of a tire, by improving the accuracy of detection of magnetic noise due to stress. The method comprises a means made of a ferromagnetic material placed along said tire. The apparatus irradiates an electromagnetic wave, through a radiation antenna, to a sensor attached to the inside of said tire, said sensor detecting said electromagnetic wave; through a detection antenna, extracting relevant data; specifically, Barkhausen noise, and subjecting it to frequency analysis. The amount of tire deformation is calculated by measuring the harmonic output of the frequency spectrum and comparing it with the magnitudes of the harmonic outputs.

On the other hand, document WO2015088372 describes a mechanical stress sensor that allows measuring signals caused by local mechanical loads and detecting various types of mechanical loads; tension, compression, and torsion, as well as reducing magnetic noise and increasing sensitivity. Said stress sensor comprises a rectangular plate of polymer material, which on its upper surface has a seat in the form of a centrally symmetric cavity where a detector is located. Inside the body of said rectangular plate, along the longitudinal axis, there is a magnetosensitive element based on an amorphous ferromagnetic microwire. Said sensitive magnet element is located inside a differential measuring coil and connected to a first pair of contact pads, via printed conductors. Said differential measuring coil is connected, via printed conductors, to a second pair of contact pads. Furthermore, both pairs of contact pads are located inside said cavity and connected to said detector.

However, disadvantages have been identified in the solutions described in the prior art. On the one hand, none of the methods described in the prior art allows for real-time measurement of tire stress. Moreover, none of these methods allows, in addition, to measure tire stress when they are in motion. On the other hand, the prior art does not provide a particular ferromagnetic material with specific magnetic properties relevant to the operation of said method.

Consequently, a method is required that allows measuring in real time the stress to which the tire is being subjected, and that allows generating a system for monitoring the stress inside the tires, in order to have instantaneous knowledge of the condition of the tires and to detect incipient failures; for example, punctures. The above in order to implement adequate maintenance and reduce the probability of accidents due to unforeseen tire failures.

### SUMMARY OF THE INVENTION

The present invention provides a method for measuring the internal stress in a tire characterized in that it comprises incorporating into said tire a material which is a combination of a rubber matrix and a plurality of microwires made of a ferromagnetic material, irradiating said tire with electromagnetic waves through an emitting antenna, receiving an electromagnetic wave absorption response from said tire through a receiving antenna, and determining the internal stress of the tire, by means of a processor operatively connected to said receiving antenna, based on said electromagnetic wave absorption response.

In a preferred embodiment, the method for measuring internal stress in a tire is characterized in that said electromagnetic waves are in the microwave spectrum.

In another preferred embodiment, the method for measuring internal stress in a tire is characterized in that said step of irradiating said tire with electromagnetic waves comprises performing a frequency sweep of electromagnetic waves.

In another preferred embodiment, the method for measuring internal stress in a tire is characterized in that said electromagnetic wave absorption response is measured in transmission.

In a further preferred embodiment, the method for measuring internal stress in a tire is characterized in that said electromagnetic wave absorption response is measured in reflection.

In another preferred embodiment, the method for measuring internal stress in a tire is characterized in that, in order to determine the stress in the tire, said processor executes the steps of: calibrating a set of applied stress magnitudes based on electromagnetic wave absorption measurements, storing the data obtained in said calibration, and determining the stress value, based on said electromagnetic wave absorption response measurement and said calibration.

In a further preferred embodiment, the method for measuring internal stress in a tire is characterized in that said material is incorporated in said tire as an additional layer which is adhered to the rubber during the manufacturing or vulcanization process of said tire.

The present invention further provides a material for measuring internal stress in a tire, characterized in that it is a combination of a rubber matrix and a plurality of microwires made of a ferromagnetic material.

In a preferred embodiment, the material for measuring internal stress in a tire is characterized in that said plurality of ferromagnetic microwires corresponds to an iron-cobalt-based alloy.

In another preferred embodiment, the material for measuring internal stress in a tire is characterized in that said plurality of ferromagnetic microwires has a coating made of an anticorrosive material.

In a further preferred embodiment, the material for measuring the internal stress in a tire is characterized in that said anticorrosive material has an amorphous molecular structure and is selected from the group consisting of polymers and glasses, as well as combinations thereof.

In another preferred embodiment, the material for measuring internal stress in a tire is characterized in that said plurality of ferromagnetic microwires are incorporated in a semi-rigid membrane.

In a further preferred embodiment, the material for measuring internal stress in a tire is characterized in that said plurality of ferromagnetic microwires are uniformly arranged in said semi-rigid membrane.

In another preferred embodiment, the material for measuring internal stress in a tire is characterized in that said semi-rigid membrane is incorporated in said tire as an additional layer which is adhered to the rubber during the manufacturing or vulcanization process of said tire.

### BRIEF DESCRIPTION OF THE FIGURES

FIG. 1 shows an isometric view of a first embodiment of a microwire forming said plurality of ferromagnetic microwires.

FIG. 2 shows a section view of a first embodiment of a microwire forming said plurality of ferromagnetic microwires.

FIG. 3 shows a top view of a first embodiment of a microwire forming said plurality of ferromagnetic microwires.

FIG. 4 shows an isometric view of a first embodiment of said additional layer comprising said semi-rigid membrane containing said plurality of ferromagnetic microwires.

FIG. 5 shows a schematic of a two-port network, with the respective incident and reflected waves.

### DETAILED DESCRIPTION OF THE INVENTION

Essentially, the present invention provides a method for measuring stress in a tire comprising the steps of: incorporating into said tire a material which is a combination of a rubber matrix and a plurality of microwires (1a, 1b, 1c) made of a ferromagnetic material (11), irradiating said tire with electromagnetic waves through an emitting antenna, receiving an electromagnetic wave absorption response from said tire through a receiving antenna, and determining the internal stress of the tire, by means of a processor operatively connected to said receiving antenna, based on said electromagnetic wave absorption response.

In the context of the present invention, a matrix will be understood as a portion or piece of some material, which defines a support for other objects or materials of smaller dimensions. Said matrix may be of a regular or irregular shape, which does not limit the scope of the present invention. Additionally, the dimensions of said matrix are not a limiting factor in the present invention.

Moreover, in the context of the present invention and without limiting the scope thereof, a microwire will be understood as an object having an elongated shape, wherein at least one of its dimensions is in the microscale, that is, having a length in the micrometer range. In a preferred embodiment, without limiting the scope of the present invention, said microwires may have two or all three of their dimensions in the microscale range. In a preferred embodiment, without limiting the scope of the present invention, said microwires may have a cross section which may be, for example and not limited to, polygonal, circular, elliptical, oval, irregular polygonal.

Said microwires (1a, 1b, 1c) of ferromagnetic material (11) have the advantage that, due to their composition, their magnetic properties are sensitive to stress. Said magnetic properties are: low coercive field, near-zero magnetostriction, and helical domain structure. Materials with said magnetic behavior usually show giant magneto-impedance, which is the effect associated with the abrupt variation of the permeability of the magnetic material, which is sensitive to the applied stress and can be detected as a variation in the microwave absorption near the resonance frequency of the system. Consequently, its magnetic properties are modified in response to an applied stress. Said behavior may be, advantageously and without limiting the scope of the present invention, measured by using of electromagnetic waves. This is because the electromagnetic absorption response of said microwires (1a, 1b, 1c) will be modified when subjected to stress. This, in turn, may be used to measure stress in tires, as performed in the method which is the subject of the present invention.

The incorporation of said material in said tire does not limit the scope of the present invention and may be total or partial, that is, it may be added throughout the entire tire, or in a portion thereof. Additionally, said material may be incorporated into said tire during or after the manufacture or vulcanization of said tire, without limiting the scope of the present invention. For example, and without limiting the scope of the present invention, the incorporation of said material into said tire may be as an additional layer (2) that is adhered to the rubber matrix of said tire, or as a layer that is added to the tire in its manufacturing or vulcanization process.

In a preferred embodiment, and without limiting the scope of protection, said material that is incorporated in said tire corresponds to a semi-rigid membrane (21) which is added throughout the tire as an additional layer (2) to the rubber in its manufacturing or vulcanization process. In this case, without limiting the scope of the present invention, the stress applied on said semi-rigid membrane (21) is representative of said tire. Therefore, the stress applied on the ferromagnetic microwires (1a, 1b, 1c) will be an identical representation of the stress undergone by the rubber matrix in the tire. However, in other cases, without limiting the scope of the present invention, said semi-rigid membrane (21) is installed as an additional layer (2) in a modular manner inside the tire, at the time of its assembly on the vehicle wheel.

On the other hand, with respect to said emitting antenna in charge of irradiating said tire with electromagnetic waves and said receiving antenna in charge of measuring the electromagnetic wave absorption parameter, these may be positioned adjacent to each other and in the immediate surroundings of said tire which is the object of measurement. The degree of incidence of said electromagnetic waves on said ferromagnetic microwires does not represent a limiting characteristic for the present invention. In this sense, the orientation of said antennas does not limit the scope of protection; they may be positioned horizontally, vertically, or obliquely with respect to said tire when said tire is normally in use. However, in a preferred embodiment and without limiting the scope of the present invention, it is preferable to irradiate perpendicularly to the arrangement of the ferromagnetic microwires (1a, 1b, 1c), with the objective of avoiding a progressive loss of sensitivity.

In a preferred embodiment, and without limiting the scope of protection, said antennas may be positioned on an inner surface of a portion of the wheel cover that is the object of measurement and having a horizontal orientation.

The frequency of said electromagnetic waves does not limit the scope of the present invention and may depend, for example and without limiting the scope of the present invention, on the dimensions of the ferromagnetic microwires (1a, 1b, 1c), on the dimensions of the tire, and on the dimensions of said transmitting antenna and said receiving antenna. Additionally, and as will be explained in detail below, said emitting antenna may emit electromagnetic waves at a single frequency or at a plurality of frequencies without limiting the scope of the present invention. In a preferred embodiment, without limiting the scope of the present invention, said electromagnetic waves which are irradiated by said transmitting antenna and measured by said receiving antenna have a frequency range of between 500 MHz and 1 THz, and have a wavelength in vacuum of between 300 μm and 60 cm, that is, which are in the microwave spectrum.

Additionally, in a preferred embodiment, said step of irradiating said tire with electromagnetic waves comprises performing a frequency sweep of electromagnetic waves. However, other irradiation options are possible without limiting the scope of the present invention, which may be, but not limited to, a discrete set of frequencies, a wave packet, or irradiating at a single frequency.

In the context of the present invention, a frequency sweep will be understood as an analysis of a frequency range which is based on detecting the absorption or emission of electromagnetic radiation at a plurality of frequencies or wavelengths.

On the other hand, the magnetic parameter or characteristic to be measured is the electromagnetic wave absorption response. Said absorption response may be measured, in a preferred embodiment and without limiting the scope of the present invention, in a frequency range of between 1 and 20 GHz. Said parameter may be measured both in transmission and in reflection, as well as in a combination of both configurations. When measurements are made in transmission, the scattering parameter Sit is measured, whereas when measurements are made in reflection, the scattering parameter is measured.

To a person with average knowledge in the technical field, it is understood that scattering parameters, or S-parameters, are properties used to study the response of a system, for example and without limiting the scope of the present invention, of linear electrical networks, when subjected to various steady-state stimuli by signals external to the system. Although applicable to any frequency, the S-parameters are mainly used for networks operating at radio frequency (RF) and microwave frequencies. S-parameters are represented in a matrix, thus following the rules of matrix algebra. Many useful electrical properties of networks or components may be expressed by these parameters, for example, gain, return loss, voltage standing wave ratio (VSWR), reflection coefficient, and amplifier stability. The use of these parameters may be extended to systems other than electrical networks, as in the case of the present invention.

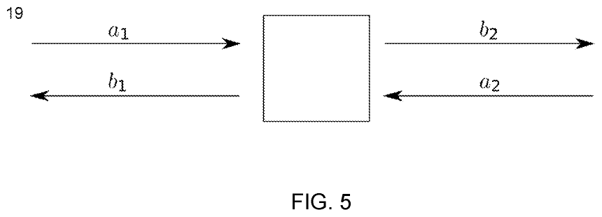

The S-parameter matrix for a two-port network is one of the most common and is used as a basis for developing higher order matrices corresponding to larger networks. A schematic of said two-port network is shown in FIG. 5.

In this case, the relationship between the reflected and incident power waves and the S-parameter matrix is given by:

$$( \begin{matrix}{b}_{1} \\ {b}_{2}\end{matrix} ) = ( \begin{matrix}{S}_{11} & {S}_{12} \\ {S}_{21} & {S}_{22}\end{matrix} ) ( \begin{matrix}{a}_{1} \\ {a}_{2}\end{matrix} )$$

Where:
a₁ and a₂ correspond to incident waves.
b₁ and b₂ correspond to reflected waves.

From this matrix, the following relationships for the scattering parameters are obtained:

$${S}_{11} = \frac{{b}_{1}}{{a}_{1}} = \frac{{V}_{1}^{-}}{{V}_{1}^{+}} \\ {S}_{12} = \frac{{b}_{2}}{{a}_{1}} = \frac{{V}_{2}^{-}}{{V}_{1}^{+}} \\ {S}_{21} = \frac{{b}_{1}}{{a}_{2}} = \frac{{V}_{1}^{-}}{{V}_{2}^{+}} \\ {S}_{22} = \frac{{b}_{2}}{{a}_{2}} = \frac{{V}_{2}^{-}}{{V}_{2}^{+}}$$

Each S-parameter of a two-port network has the following generic descriptions:
S₁₁ is the reflection coefficient of the input port stress.
S₁₂ is the gain of the reverse stress.
S₂₁ is the gain of the direct stress.
S₂₂ is the reflection coefficient of the output port stress.

On the other hand, in order to determine the stress inside said tire, said processor is configured to perform the steps of:
calibrating a set of applied stress magnitudes based on electromagnetic wave absorption measurements;
storing the data obtained in said calibration; and
determining the value of the stress, based on said electromagnetic wave absorption response measurement and said calibration.

The processes executed by said processor to achieve said configuration as mentioned above do not limit the scope of protection.

However, in a preferred embodiment and without limiting the scope of the present invention, said processor operates as follows:

To obtain said calibration, said processor establishes a correlation between the stress magnitudes applied on the material and the absorption of electromagnetic wave; applying certain predetermined stress values to the material and measuring the electromagnetic wave absorption response for said predetermined stress values. To measure said electromagnetic wave absorption response, said processor commands a transmitting antenna to irradiate an electromagnetic wave, and said processor receives from a receiving antenna an electromagnetic wave absorption response in the reflected wave. Said stress values and said absorption responses are stored in a data storage unit. Finally, in order to determine the stress value, based on said calibration established in the beginning, the electromagnetic wave absorption response values are interpolated or extrapolated, using said calibration, to obtain said stress values. This stress determination may be executed in a substantially continuous manner, at regular intervals, or at specific instants, while the tire is in motion, without limiting the scope of the present invention.

The present invention further provides a material characterized in that it is a combination of a rubber matrix and a plurality of microwires (1a, 1b, 1c) of a ferromagnetic material (11).

Said plurality of ferromagnetic microwires (1a, 1b, 1c) may comprise any ferromagnetic material, which does not limit the scope of the present invention. In a preferred embodiment, said ferromagnetic material corresponds to an amorphous iron-cobalt-based alloy. In a more preferred embodiment, and without limiting the scope of protection, said ferromagnetic material corresponds to an alloy based on iron, cobalt, boron, and silicon. On the other hand, without limiting the scope of the present invention, said ferromagnetic microwires (1a, 1b, 1c) may undergo additional processes during their manufacture, with the aim of improving their physical properties. Said additional processes may be, for example and without being limited to, heat treatments, thermochemical treatments, mechanical treatments, surface treatments, among others. In a preferred embodiment, and without limiting the scope of protection, said ferromagnetic material is subjected to heat treatment in combination with the simultaneous application of stress or external magnetic fields. In the context of the present invention, without limiting the scope thereof, the selected ferromagnetic material (11) may have the following magnetic properties that favor the measurement of the above-mentioned parameters: near-zero magnetostriction; very low coercive field; and helical magnetic anisotropy.

Additionally, each of the microwires (1) of said plurality of ferromagnetic micro wires (1a, 1b, 1c) may have a coating. Said coating may perform various functions of protecting the ferromagnetic microwires (1a, 1b, 1c), as well as coupling said microwires to the semi-rigid membrane (21). In a preferred embodiment, without limiting the scope of the present invention, said ferromagnetic microwires (1a, 1b, 1c) have a coating formed by an anticorrosive material (12).

In the context of the present invention, an anticorrosive material (12) will be understood as an additive which is added to said ferromagnetic material with the objective of insulating it and preventing wear due to the action of external agents.

Said anticorrosive material (12) has an amorphous molecular structure, that is, a material whose constituent particles do not have an ordered structure; therefore, they lack well-defined shapes, and may be selected from the group formed by polymers and/or glasses.

In a preferred embodiment, and without limiting the scope of protection, said anticorrosive material (12) is selected from the group formed by: polycarbonate, polyethylene, nylon, silica glass, pyrex, among others. In a more advantageous embodiment, said coating formed by an anticorrosive material (12) is pyrex (borosilicate glass).

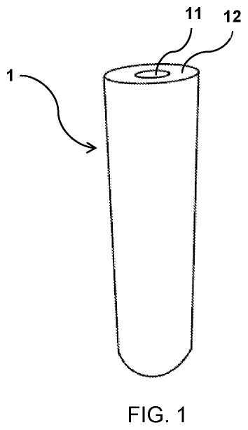

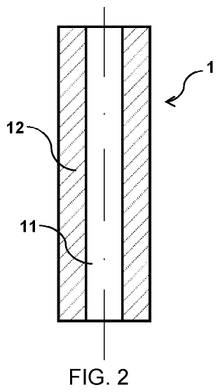

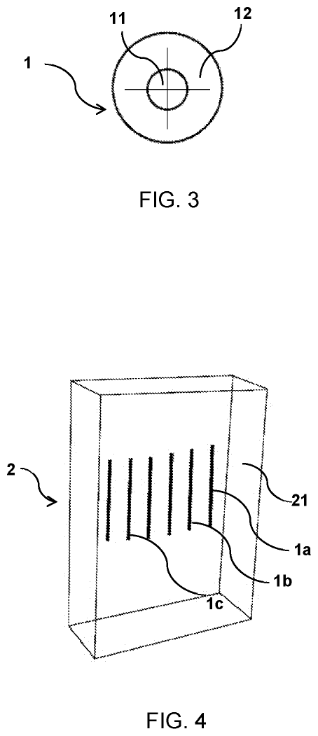

As illustrated in FIGS. 1, 2, and 3, without limiting the scope of the present invention, each of the microwires (1) forming said plurality of ferromagnetic microwires (1a, 1b, 1c) which are incorporated in said semi-rigid membrane (21) may have an elongated shape. In a preferred embodiment, without limiting the scope of the present invention, said ferromagnetic microwires (1a, 1b, 1c) may have a cylindrical geometry. In this preferred embodiment, without limiting the scope of the present invention, the dimensions of said ferromagnetic microwires (1a, 1b, 1c) are not a limiting feature in the present invention.

In a preferred embodiment, and without limiting the scope of protection, each of said microwires (1) forming said plurality of ferromagnetic microwires (1a, 1b, 1c) has a metallic core which may vary between 1 and 30 μm. Additionally, said coating material of an anticorrosive material (12) may have a thickness of between 1 and 20 μm, thus, the total thickness may be between 5 and 50 μm.

Said plurality of ferromagnetic microwires (1a, 1b, 1c) may be arranged in any manner on said semi-rigid membrane (21). For example, and without limiting the scope of the present invention, said plurality of ferromagnetic microwires (1a, 1b, 1c) may be arranged in a uniform manner on said semi-rigid membrane (21), as shown in FIG. 4. In this exemplary embodiment, the distribution pattern of said microwires (1a, 1b, 1c) along said semi-rigid membrane (21) is not a limiting feature in the present invention. However, in other preferred embodiments, said plurality of ferromagnetic microwires (1a, 1b, 1c) may be arranged in a localized or random manner on specific portions of said semi-rigid membrane (21).

Additionally, the density of ferromagnetic microwires (1a, 1b, 1c) distributed on the surface of said semi-rigid membrane (21) does not limit the scope of protection. In a preferred embodiment, and without limiting the scope of protection, said microwires (1a, 1b, 1c) are distributed along said semi-rigid membrane (21) with a spacing of between 1 and 5 millimeters from each other. In a more advantageous embodiment, each of said microwires (1) forming said plurality of ferromagnetic microwires (1a, 1b, 1c) are distributed along said semi-rigid membrane with a spacing of 2 millimeters from each other.

According to the previously detailed description it is possible to obtain a method and a material for measuring the internal stress in tires. Said method has the advantage that it allows to measure in real time the stress to which the tire is being subjected. The aforementioned allows to provide instantaneous knowledge of the state of the tire and facilitates the detection of incipient failures. In addition, it allows to provide greater knowledge of the health status of the tire, and even to monitor its use.

It should be understood that options described for different technical characteristics, both in the case of the method and the material which are the object of the present invention, may be combined with each other in any manner foreseen by a person with average knowledge in the technical field without limiting the scope of the present invention.

1. A method for measuring the internal stress in a tire, CHARACTERIZED in that it comprises:
a) incorporating into said tire a material which is a combination of a rubber matrix and a plurality of microwires (1a, 1b, 1c) made of a ferromagnetic material (11);
b) irradiating said tire with electromagnetic waves through an emitting antenna;
c) receiving an electromagnetic wave absorption response from said tire through a receiving antenna; and
d) determining the internal stress of the tire, by means of a processor operatively connected to said receiving antenna, based on said electromagnetic wave absorption response.

2. The method according to claim 1, CHARACTERIZED in that said electromagnetic waves are in the microwave spectrum.

3. The method according to claim 1, CHARACTERIZED in that said step of irradiating said tire with electromagnetic waves comprises performing a frequency sweep of electromagnetic waves.

4. The method according to claim 1, CHARACTERIZED in that said electromagnetic wave absorption response is measured in transmission.

5. The method according to claim 1, CHARACTERIZED in that said electromagnetic wave absorption response is measured in reflection.

6. The method according to claim 1, CHARACTERIZED in that, in order to determine the stress in the tire, said processor executes the steps of:
calibrating a set of applied stress magnitudes based on electromagnetic wave absorption measurements;
storing the data obtained in said calibration; and
determining the stress value, based on said electromagnetic wave absorption response measurement and said calibration.

7. The method according to claim 1, CHARACTERIZED in that said material is incorporated in said tire as an additional layer (2) which is adhered to the rubber during the manufacturing or vulcanization process of said tire.

8. A material for measuring internal stress in a tire, CHARACTERIZED in that it is a combination of a rubber matrix and a plurality of microwires made of a ferromagnetic material (1a, 1b, 1c).

9. The material according to claim 8, CHARACTERIZED in that each of the microwires (1) of said plurality of ferromagnetic micro wires (1a, 1b, 1c) corresponds to an iron-cobalt-based alloy.

10. The material according to claim 8, CHARACTERIZED in that each of the microwires (1) of said plurality of ferromagnetic micro wires (1a, 1b, 1c) has a coating made of an anticorrosive material (12).

11. The material according to claim 10, CHARACTERIZED in that said anticorrosive material (12) has an amorphous molecular structure and is selected from the group consisting of polymers and glasses, as well as combinations thereof.

12. The material according to claim 10, CHARACTERIZED in that said plurality of ferromagnetic microwires (1a, 1b, 1c) are incorporated in a semi-rigid membrane (21).

13. The material according to claim 12, CHARACTERIZED in that said plurality of ferromagnetic microwires (1a, 1b, 1c) are uniformly arranged in said semi-rigid membrane (21).

14. The material according to claim 12, CHARACTERIZED in that said semi-rigid membrane (21) is incorporated in said tire as an additional layer (2) which is adhered to the rubber during the manufacturing or vulcanization process of said tire.
